(19) United States
(12) Patent Application Publication
(10) Pub. No.: US 2016/0239636 A1
(43) Pub. Date: Aug. 18, 2016

(54) GENOMIC PRESCRIBING SYSTEM AND METHODS

(71) Applicant: THE UNIVERSITY OF CHICAGO, Chicago, IL (US)

(72) Inventors: Peter H. O'Donnell, Chicago, IL (US); Mark J. Ratain, Chicago, IL (US); Keith Danahey, Chicago, IL (US)

(73) Assignee: The University of Chicago, Chicago, IL (US)

(21) Appl. No.: 15/027,099

(22) PCT Filed: Oct. 7, 2014
(86) PCT No.: PCT/US2014/059472

§ 371 Date: Apr. 4, 2016

Related U.S. Application Data
(60) Provisional application No. 61/887,767, filed on Oct. 7, 2013.

(51) Int. Cl. G06F 19/00

(52) U.S. Cl. CPC G06F 19/3456; G06F 19/3431; G06F 19/3443

(57) ABSTRACT

A genomic prescribing system and methods utilizes pharmacogenomic information to enhance patient-centered care by delivering preemptively-obtained, patient-specific pharmacogenomic results with accompanying prescribing recommendations.

### CROSS-REFERENCE TO RELATED APPLICATIONS

This application claims the benefit of U.S. Provisional Patent Application No. 61/887,767 filed Oct. 7, 2013, which is incorporated by reference.

### STATEMENT REGARDING FEDERALLY SPONSORED RESEARCH

This invention was made with government support under K23 GM 100288-01A1, K12 CA139160-01A1, 5 U01 HL105198-09 awarded by the National Institutes of Health (NIH). The government has certain rights in the invention.

### FIELD OF THE INVENTION

The invention relates to pharmacogenomics and the incorporation of genetic information into the process of providing healthcare services, including prescribing medication. More specifically, the invention is a patient genotype-based tool for personalized evaluation of the possible risks associated with prescribing a medication.

### BACKGROUND OF THE INVENTION

Adverse drug reactions are the fifth leading cause of death in the United States, and thousands of additional patients are prescribed medications from which they derive no benefit; overall efficacy rates for even the most common drugs treating the most prevalent diseases have been estimated to be only about 50%. Furthermore, it has been suggested that the healthcare system wastes billions of dollars annually on poor prescription drug choices notwithstanding the direct cost of such failures to patients.

The prospect of attaining a future of more informed prescribing practice in the medical system has become possible through the advance of technology and the ability to rapidly and accurately determine millions of pieces of genetic variation information for large numbers of individuals. This has led to the identification of genetic factors governing response and toxicity for hundreds of drugs, with many such associations now replicated, incorporated into drug labels, and encompassed by clinical prescribing guidelines. Many encourage the increased use of pharmacogenomic testing as a step towards more personalized medicine.

Pharmacogenomics (PGx) is the study of how a person's genetic make-up determines response to drugs. The way a medication affects an individual is often varied and depends, to a certain degree, on genes and variations in those genes. Being able to predict who will respond well to a certain drug or who may develop serious side effects is a major goal of pharmacogenomic research. Pharmacogenomics may assist physicians to prescribe the most effective medication at the correct dose for each patient. Pharmacogenomic information (otherwise referred to as “pharmacogenomic data”) may be valuable for all types of healthcare providers, including medical doctors, surgeons, doctors of osteopathy, optometrists, psychologists, dentists, chiropractors, veterinarians, other physicians, physicians' assistants, nurse practitioners, pharmacists, nurses, and others. Pharmacogenomic information also can be valuable to patients when making healthcare decisions.

A “gene” is a molecular unit of heredity of a living organism. More specifically, a gene is a specific sequence of nucleotides in deoxyribonucleic acid (DNA) that is the functional unit of inheritance controlling the transmission and expression of one or more traits by specifying the structure of a particular polypeptide and especially a protein or controlling the function of other genetic material.

Most people have two sets of each gene—one set from one parent and another set from the other parent. Certain exceptions include genes that are only on an X chromosome or a Y chromosome. Males receive a Y chromosome from their father, and an X chromosome from their mother, so males have only one type of gene if that gene only occurs on the X chromosome or only on the Y chromosome. In contrast, females receive an X chromosome from each of the parents.

A person's genes form the person's genotype. More specifically, the term “genotype” may refer to one or more genetic markers including all of the genes that a person has, all of the genes that a person has related to one physical trait, or all of the genes that a person has at one location in a chromosome. A physical trait resulting from one or more genes is called a “phenotype”.

While the terms genotype and phenotype are typically limited to the genes and the related expression, the term “genome” means the entirety of the person's hereditary information including, not only the genes in the DNA, but other portions, DNA such as noncoding DNA. In contrast to genes, noncoding DNA is not directly responsible for creating proteins to perform certain cellular functions, but, in some cases, have another biological function.

Each of the different possible genes at one location in a chromosome is called an “allele”. Each allele may have different set of nucleotides. Nucleotides are molecules including adenine (A), thymine (T), guanine (G), and cytosine (C) in human DNA and uracil (U) in human RNA. Adenine pairs with thymine and guanine pairs with cytosine. One example of an allele is a DNA sequence of nucleotides “AATGTCG”. Another allele of the same gene could include a DNA sequence with one different nucleotide—e.g., “ACTGTCG”—or multiple different nucleotides. When two sections of DNA, each from the same location on a chromosome, have only one different nucleotide, this is called a “single-nucleotide polymorphism” (SNP) Certain lo single nucleotide polymorphisms are linked to susceptibility for certain health conditions. For example, a single change in a nucleotide of a gene called apolipoprotein E is associated with a higher risk of Alzheimer disease.

Certain other differences in DNA are also associated with increased susceptibility for certain health conditions. For example, genes named BRCA1 and BRCA2 code for tumor suppressor proteins. Certain mutations in these genes, such as deletion or addition of one or more nucleotides, are associated with a higher susceptibility for developing breast cancer and ovarian cancer.

Additional discoveries have been made regarding how portions of DNA—e.g., one or more genes—effect the body's processing of certain drugs including pharmaceutical drugs and non-pharmaceutical drugs. Certain genes have been identified as having an effect on the optimal dosage of a drug, prevalence of adverse effects from a drug, and level of effectiveness of a drug. For example, some gene variations affect the physiological response to medication including how an organism absorbs, distributes, metabolizes, or excretes a drug.

Advances in sequencing technology have led to the identification of genetic factors governing drug response and toxicity for hundreds of drugs—i.e., pharmacogenomics. This valuable data could be used to help predict adverse reactions and determine whether patients are likely to respond to therapeutic options.

To date, the great productivity in pharmacogenomic discoveries has been poorly translated to more effective patient care. Genomic information is expensive to acquire in real time, complex, and difficult to interpret. By making pharmacogenomic information more prompt, accessible, and understandable for physicians, genomic discovery can be translated to improved patient care. For example, a system and methods would be valuable that manages and provides pharmacogenomic information to patients and healthcare providers quickly, efficiently, and in an easy to understand manner.

Some efforts have been made to develop such systems and methods. However, these systems and methods are associated with certain disadvantages. For example, certain known systems store data about pharmacogenomics, but do not provide the data in a format easily understood by all users (including physicians) who generally lack training and experience in interpretation of pharmacogenomic results.

Other known systems offer general data about pharmacogenomics, but do not store any information specific to a patient or provide only limited information about a patient. For example, if a patient has a relative with breast cancer, the patient may have genetic testing done with respect to the BRCA1 and BRCA2 genes, but no other gene information is made available through this testing.

Still other known systems permit storage of data about pharmacogenomics, either with or without certain patient information, but do not identify the sources of any of the pharmacogenomic information.

Although clinical literature suggests that a population of patients may respond to any given medication, individual response often varies greatly. Some of these responses are reflected by increased costs associated with prolonged hospitalizations, adverse drug reactions, or no response to medication. Annually, 100 billion dollars are spent on patients who have experienced an adverse drug response, or one or more variations in physiological responses. To date, pharmacogenomic information has simply been catalogued in the literature, and at best, has led to a limited number of FDA drug-label changes.

What is needed is a system and methods using genetic information in routine clinical practice for medication treatment decisions. The invention satisfies this need.

### SUMMARY OF THE INVENTION

The invention utilizes genomics-based personalized medicine that may significantly reduce the incidence of adverse drug reactions, as well as increase prescribing accuracy by helping physicians choose drugs that are most likely to benefit the patient. These benefits may ultimately result in increased patient health and decreased system-wide health costs. The terms “physician” and “user” designate any person or entity using the system according to the invention and are used interchangeably.

The invention brings pharmacogenomic data and broad genomic testing together and takes the critical next step to bring this information into routine clinical practice. Specifically, the invention creates a database of patient genomic and prescribing information and curated, concise pharmacogenomic data that enables physicians and patients to make informed decisions about prescribing in real time.

According to the invention, comprehensive information is managed and delivered to patients and healthcare providers quickly, efficiently, and in an easy-to-understand manner. In one embodiment, the invention includes an interface that delivers information regarding drug-gene correlations, connections between the aforementioned correlations and published literature, and drug substitutions.

More specifically, the information includes patient-specific genetic data, possible risks of one or more interactions with a medication as well as recommendations for prescribing the medication, i.e., dose, intake frequency and duration. Patient-specific pharmacogenomic results allow a physician to estimate the subject's genetically determined response to a particular medication, review the work (e.g., literature regarding research studies and reports) that underlies such an estimate, and consider the appropriateness of proposed alternative medications for the subject. Thus, an object of the invention is to improve prescription decision-making and prescribing behaviors. The invention facilitates physicians to pre-identify patients who are most likely to experience severe side effects from medications, or to predict which of their patients might require alternative dosing. It could also prove beneficial by identifying those patients who are most likely to respond to a given medication.

For purposes of this application, the invention is discussed in reference to human pharmacogenomics, but the discussion is merely exemplary. The invention is applicable to pharmacogenomics related to any living subject, such as a vertebrate, insect, plant or bacterium. The term “subject” or “patient” are used interchangeably within this specification and may include any cell, tissue, or organism, human or non-human.

Physicians and patients have become increasingly aware that people often react or respond to drugs very differently, even when a drug is being used to treat the same condition. Recent research shows that individual genetic makeup often explains why a subject tolerates or responds to a given drug. The term “drug” and “medication” are used interchangeably with this specification and include any therapeutic remedy, for example, aspirin, hydrochlorothiazide, atorvastatin, lisinopril, amlodipine, metoprolol, levothyroxine, simvastatin, omeprazole, atenolol, losartan, furosemide, warfarin, esomeprazole, metformin, prednisone, fluticasone propionate, to name a few. It is contemplated that a drug may be prescribed for diseases or abnormalities occurring in any branch of medicine, for example, internal medicine, nephrology, cardiology, oncology, gastroenterology, pulmonology, hepatology, to name a few.

The invention incorporates prospective pharmacogenomic testing into routine medical care, such as prescribing clinical drugs. It creates an interactive, patient-specific, protected-access, web-based tool for providers that supports ongoing pharmacogenomic consults throughout patient care.

Certain embodiments of the invention include a system and methods configured to manage and deliver patient-specific pharmacogenomic information to patients and healthcare providers. Other embodiments of the invention may be adapted for use by drug development or drug testing entities.

In one embodiment, the invention is an electronic decision-support system delivering preemptively-obtained, patient-specific pharmacogenomic results with accompanying prescribing recommendations. Further, the invention provides recommendations for alternative prescriptions to currently prescribed drugs, and the ability to look for new prescriptions for particular indications.

The invention unites pharmacogenomic data and broad, one-time, genetic testing on a per-patient basis in one easy to access and secure package, including compliance with all government rules, mandates and regulations such as the U.S. Health Insurance Portability and Accountability Act (HIPAA). Specifically, the invention includes a plurality of databases including a patient specific database of genomic and pharmacogenomic information to assist physicians with prescribing medications. Each database of the invention is search enabled to allow pre-emptive exploration of all possible prescribing options against a patient profile, enabling physicians and patients to make informed decisions about prescribing in real time. As known to those skilled in the art, search functions may be performed using text fields, check boxes, and drop-down lists, to name a few.

In one embodiment of the invention, the system has the capacity to assimilate a large number of genomic data points for a given subject at once, enabling the system and the user to compare and contrast multiple drug options for patient subject, using the pre-emptively obtained genomic data and the database of curated therapeutics.

Other databases according to the invention may include, for example, a database directed to connections between correlations and published literature and/or a database directed to common drug substitutions. Other databases according to the invention may be directed towards drug-drug interactions that are influenced by genetics. It is contemplated that additional databases may be used or created by the genomic prescribing system. For example, databases may include distribution of genetic markers in patient populations, distribution of medications considered for each patient population, frequency of medication substitution in response to patient genetic information, and incidence of genetically suboptimal medication decisions.

The databases contemplated by the invention may be useful toward the economic and health benefits of pharmacogenomics as well as ways to optimize the implementation of genomic prescribing system according to the invention. With the addition of data associated with adverse medical events and/or therapeutic outcomes, this data becomes a treasure trove of pharmacogenomic relationships. It both creates a new and expanded set of marker-medication correlations and establishes estimates of the overall cost and effectiveness of available therapeutic options.

The invention includes a database directed to drug-gene interactions, but may also include a database directed to drug-drug-gene interactions for those patients prescribed two or more medications. It is also contemplated that certain databases of the invention may also include information about drugs not related to genetics and genomics, such as drug-drug interactions, drug-food interactions, drug-environment interactions, drug dosage information, legal regulations related to drugs, drug symptom information, drug condition information, and other drug information.

Once the genetic markers of a patient has been ascertained, the one or more databases allow the clinician to estimate the patient's genetically determined response to a particular medication, review the work that underlies such an estimate; and, consider the appropriateness of alternative medications for the patient.

Advantages of the invention include avoiding adverse effects of certain drug-gene interactions, cost savings for treating preventable adverse effects, improving drug dosage identification without resorting to trial and error, avoiding prescribing medications that will not be effective, and making up-to-date research information quickly available and easily accessible to patients and healthcare providers.

The invention and its attributes and advantages will be further understood and appreciated with reference to the accompanying drawings.

### BRIEF DESCRIPTION OF THE DRAWINGS

The preferred embodiments of the invention will be described in conjunction with the appended drawings provided to illustrate and not to the limit the invention, where like designations denote like elements, and in which:

FIG. 1 illustrates an embodiment of the overall structure according to the invention.

FIG. 2 illustrates a table including a set of variants probed using a specialized genotyping technique for a specific gene according to the invention.

FIG. 3 illustrates an embodiment of the genomic prescribing system according to the invention.

FIG. 4 illustrates a flow chart according to one embodiment of the invention.

FIG. 5 illustrates an embodiment of a user interface according to the invention.

FIG. 6 illustrates another embodiment of a user interface according to the invention.

FIG. 7 illustrates an embodiment of a clinical summary element according to the invention.

### DETAILED DESCRIPTION

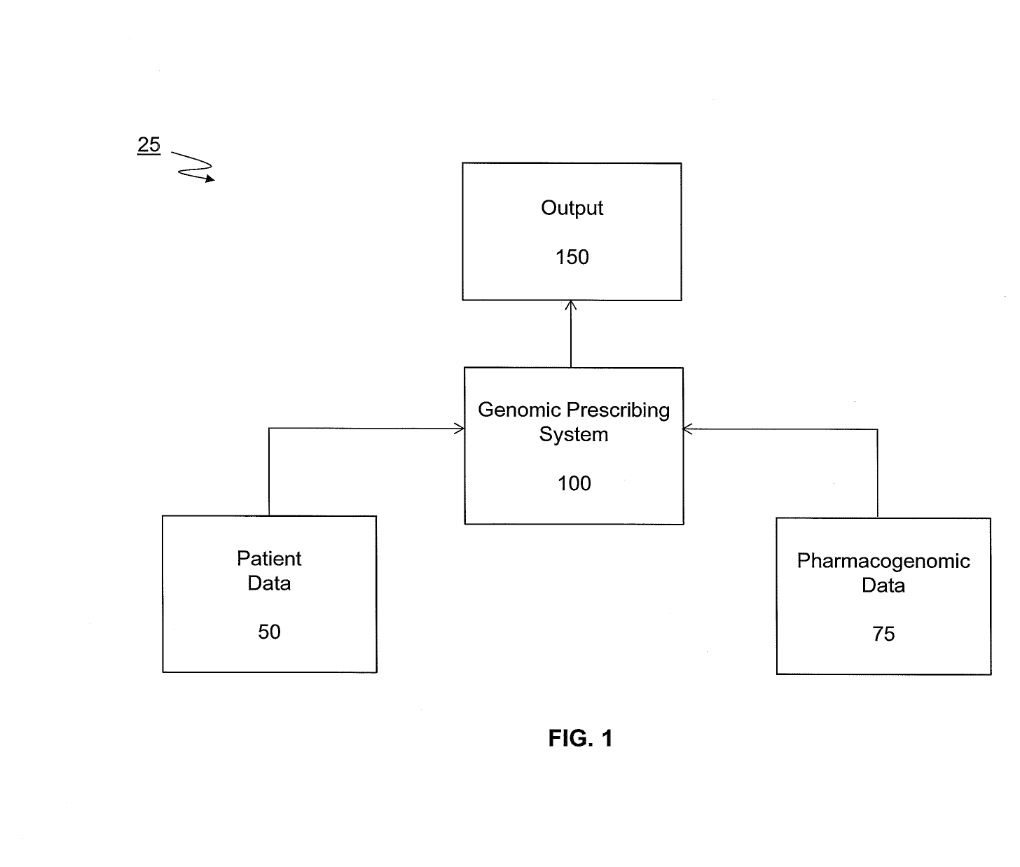

FIG. 1 illustrates the genomic prescribing structure 25 and related methods according to one embodiment the invention. The genomic prescribing structure 25 includes a genomic prescribing system 100 that collects and analyzes patient data 50 and pharmacogenomic data 75. The genomic prescribing system 100 further communicates results or output 150 using a user interface. The user interface enables physicians to assess a patient's genotype/drug interactions by current medication list, drug name or indication. The invention facilitates comparative assessment of possible treatments against the background of the patient's genetic profile to enable comparative prescribing of one or more medications.

According to the invention, patient data 50 includes identifying information of one or more patients such as name, age, sex, date of birth; contact information such as address, phone number, and email address; health information including health history, family history, symptoms, illnesses, diseases, and conditions. Patient data 50 also includes genotyping analysis data for each patient, such as genetic information or genomic information (also referred to as genetic markers), which may include details regarding a person's entire genome.

Patient data may be obtained from existing electronic medical record systems, entered into the user interface of the genomic prescribing system 100, uploaded from a document, or other input methods known in the art. In certain embodiments, the genotyping analysis data is obtained by analyzing genes using a mass spectrometry method across a panel of gene variants, for example, a MASS-AR-RAY/matrix-assisted laser desorption/ ionization time-of-flight method. In other embodiments, the genotyping analysis data is obtained by analyzing genes using a fluorescent probe-based assay across a panel of gene variants. An example of such a fluorescent probe based-assay assay is the TaqMan® SNP Genotyping Assay. Another example is the INVADER® assay, (also called mPCR-RETINA). The invention is applicable to all genes, for example, ABCB1, CYP2D6, CYP2C19, DPYD, HMGCR, ITPA, LPL, RAC2, UGT1A1, to name a few. Genes are analyzed using a panel of gene variants that may be a custom panel including, for example, variants selected because of compelling scientific evidence. It is also contemplated the panel may be an existing panel, such as the Sequenom ADME commercial panel, consisting of variants typically implicated in drug metabolism. As an example, gene variants may include those that have compelling scientific evidence in favor of their potential pharmacogenomic role in treatment strategies based on published research, e.g., rs4673, 2s951439, rs1208, rs238, rs1799945. According to the invention, any gene or gene variant is contemplated including all those known and not-known at the time of filing this application.

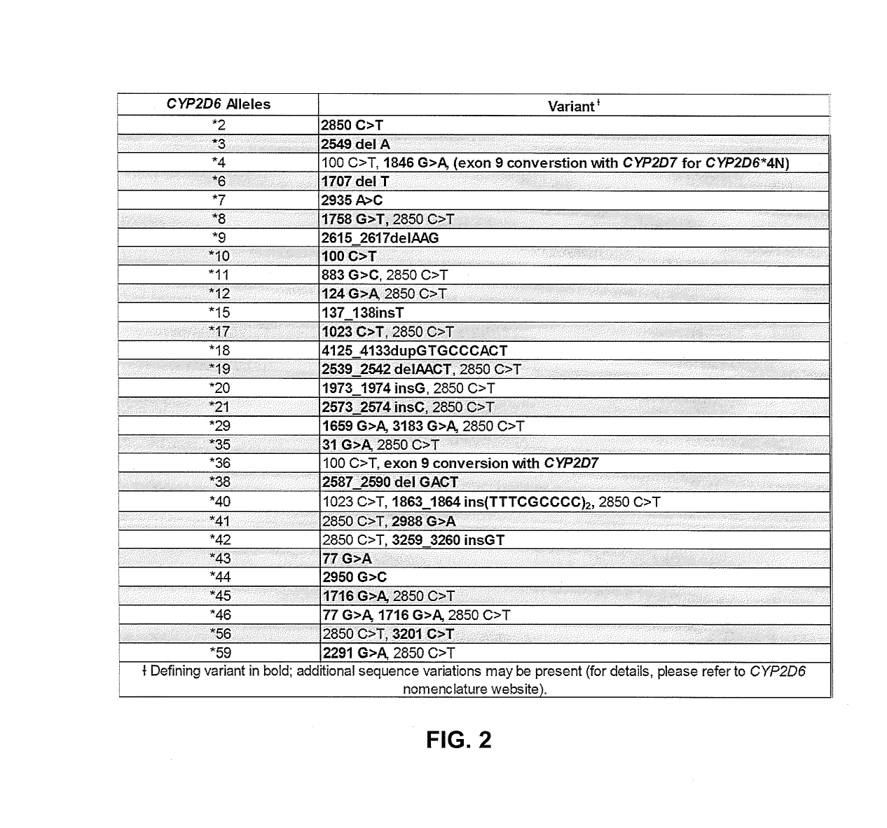

As an example, gene CYP2C9 may include variants rs72558187, rs72558188, rs1799853, rs7900194, rs72558190, rs2256871, rs9332130, rs9332131, rs28371685, rs1057910, rs56165452, rs28371686, rs9332239. More specifically, FIG. 2 illustrates a panel of variants used to assay a specific gene, CYP2D6. Depending on which alleles of the CYP2D6 gene a subject has, the subject may be categorized according to four possible categories: poor metabolizer, intermediate metabolizer, extensive metabolizer, or ultra-extensive metabolizer. A subject that eliminates a drug quickly is categorized as an ultra-rapid metabolizer, i.e., one or more alleles result in increased enzyme activity compared to extensive metabolizers. In contrast, a subject that eliminates a drug slowly is categorized as a poor metabolizer, i.e., two non-functional alleles and therefore little to no enzyme activity. An intermediate metabolizer has one non-functional allele and one normally functioning allele, and therefore a decreased enzyme activity. An extensive metabolizer has two normally functioning alleles and therefore a normal enzyme activity.

Turning back to FIG. 1, pharmacogenomic data 75 includes content obtained from a variety of sources. Examples of sources related to pharmacogenomic data may include research studies, peer reviewed articles, reports, non-peer reviewed published articles, secondary sources, published or unpublished raw data, published or unpublished processed data, anecdotal evidence, or other information related to maximizing the use of drugs in light of certain genes, groups of genes, or entire genomes in a patient. Pharmacogenomic information may be related to drugs in light of a specific allele, a specific gene, a group of genes, an entire genome, population genetics (e.g., trends across groups of genes in different patients), or population genomics (e.g., trends across groups of genomes in different patients). The pharmacogenomic data further includes findings based upon curation, collection and sorting of content from the sources, performed either manually or electronically. In one embodiment the findings may be represented by a clinical summary element discussed more fully below.

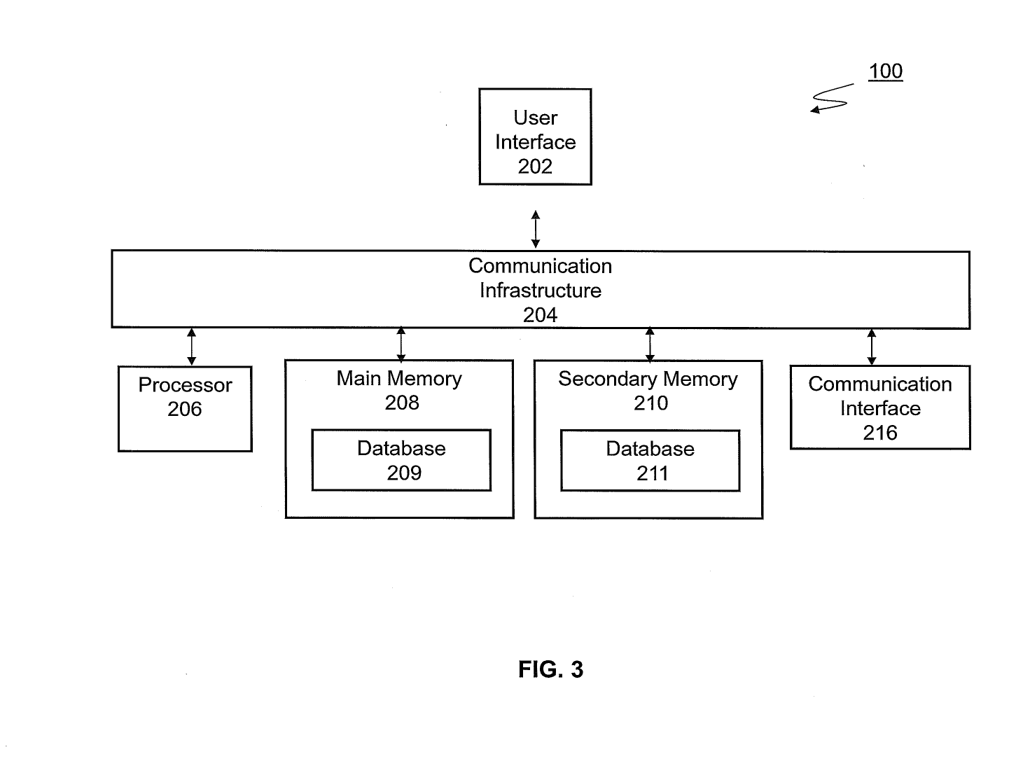

The genomic prescribing system 100 is shown in FIG. 3. The exemplary system 100 as shown may be used to implement the methods according to the invention as computer code using one or more processors 206.

The system 100 includes an input/output user interface 202 connected to communication infrastructure 204—such as a bus—, which forwards data such as graphics, text, and information, from the communication infrastructure 204 to other components of the system 100. The user interface 202 may be, for example, a display device, a keyboard, touch screen, joystick, trackball, mouse, monitor, speaker, printer, any other computer peripheral device, or any combination thereof, capable of entering and/or viewing data. It is also contemplated the interface may be a web-based interface accessible through a small-sized computer device including, for example, a personal digital assistant (“PDA”), smart hand-held computing device, cellular telephone, or a laptop or netbook computer, hand held console or MP3 player, tablet, or similar hand held computer device, such as an iPad®, iPad Touch® or iPhone®.

The system 100 includes one or more processors 206, which may be a special purpose or a general-purpose digital signal processor that processes certain information. The genomic prescribing system 100 also includes a main memory 208 and/or secondary memory 210. Main memory 208 includes, for example, random access memory (“RAM”), read-only memory (“ROM”), mass storage device, or any combination thereof. Secondary memory 210 may include, for example, a hard disk unit, a removable storage unit, or any combination. Main memory 208 and/or secondary memory 210 may each include a database 209, 211, respectively. Database 209, 211 is a matrix, or integration of patient genomic data and pharmacogenomic data. However, the database 209, 211 may be a matrix of any data as discussed more fully below.

The system 100 may also include a communication interface 216, for example, a modem, a network interface (such as an Ethernet card or Ethernet cable), a communication port, a PCMCIA slot and card, wired or wireless systems (such as Wi-Fi, Bluetooth, Infrared), local area networks, wide area networks, intranets, etc.

It is contemplated that the main memory 208, secondary memory 210, communication interface 216, or a combination thereof, function as a computer usable storage medium, otherwise referred to as a computer readable storage medium, to store and/or access computer software including computer instructions. For example, computer programs or other instructions may be loaded into the genomic prescribing system 100 such as through a removable storage device, for example, a ZIP disk, portable flash drive, optical disk such as a CD or DVD or Blu-ray, Micro-Electro-Mechanical Systems (“MEMS”).

Communication interface 216 allows software, instructions and data to be transferred between the system 100 and external devices or external networks. Software, instructions, and/or data transferred by the communication interface 216 are typically in the form of signals that may be electronic, electromagnetic, optical or other signals capable of being sent and received by the communication interface 216. Signals may be sent and received using wire or cable, fiber optics, a phone line, a cellular phone link, a Radio Frequency (RF) link, wireless link, or other communication channels.

Computer programs, when executed, enable the genomic prescribing system 100, particularly the processor 206, to implement the methods of the invention according to computer software including instructions.

The genomic prescribing system 100 may perform any one of, or any combination of, the steps of any of the methods presented herein. It is also contemplated that the methods according to the invention may be performed automatically

The system 100 of FIG. 3 is provided only for purposes of illustration, such that the invention is not limited to this specific embodiment. It is appreciated that a person skilled in the relevant art knows how to program and implement the invention using any computer system or network architecture.

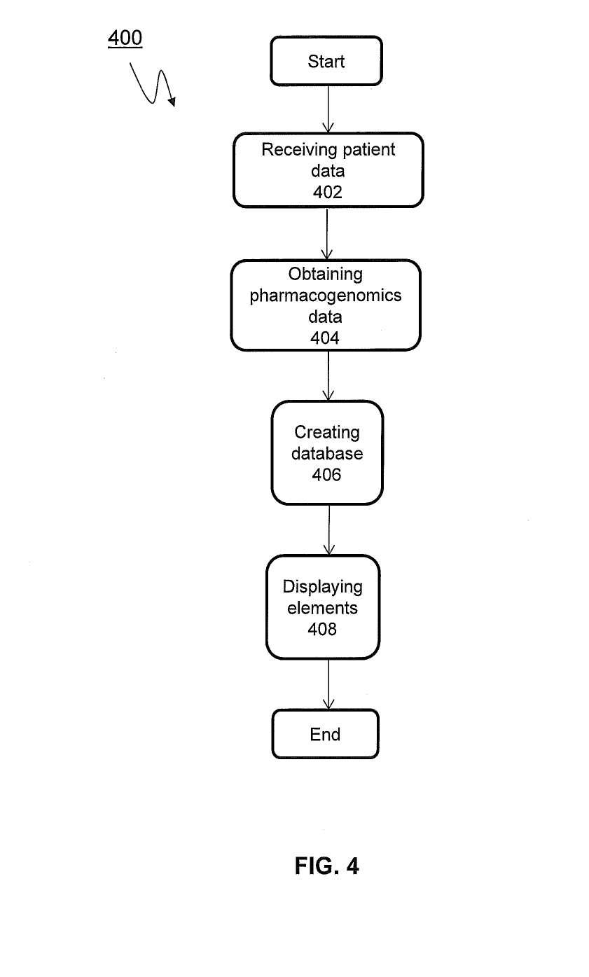

FIG. 4 is a flowchart 400 according to one embodiment of the invention. The processor receives at step 402 patient data. Patient data includes genotyping analysis data of one or more patients, such as genetic information of a patient related to one or more genetic markers. At step 404 the processor obtains pharmacogenomic data including research studies or peer reviewed articles related to the one or more genes and a medication. The processor creates at step 406 a database describing one or more correlations between the one or more genetic markers and one or more responses to the medication by the one or more patients possessing the one or more genetic markers. At step 408, a user interface is displayed that communicates patient-specific pharmacogenomic data for a drug. The interface displays a plurality of elements including at least the drug name or medication element, a pharmacogenomic signal element, and a level of evidence element. The medication element identifies the medication. A pharmacogenomic signal element identifies the known impact of each variant of the panel of gene variants on drug disposition, response, and/or toxicity. More specifically, the pharmacogenomic signal element identifies a relationship between the one or more genes and the medication. A level of evidence element is directed to all evidence supporting the implicated pharmacogenomic relationship. More specifically, the level of evidence element identifies evidence from one or more studies performed on the medication and the one or more genetic markers. The pharmacogenomic signal element and a level of evidence element are derived from a database describing the correlations between sets of genetic markers and responses to a particular medication by individuals' expressing those genetic markers.

The elements may further include a pharmacogenomic alternative element identifying a relationship between the one or more genes and the one or more alternative medications. The pharmacogenomic alternative element may be derived from a database directed to common drug substitutions.

The elements may further include a primary literature sources element identifying published literature related to the medication and the one or more genes. The primary literature sources element may be derived from a database directed to connections between correlations and published literature.

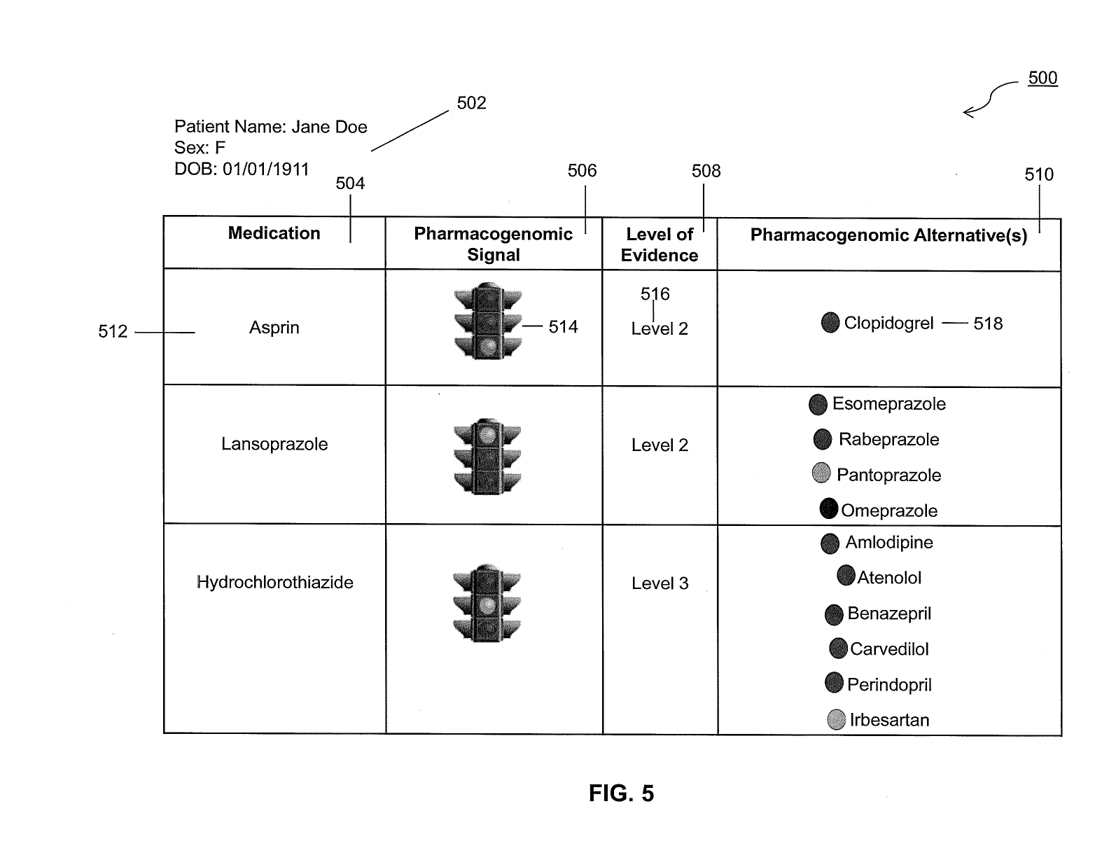

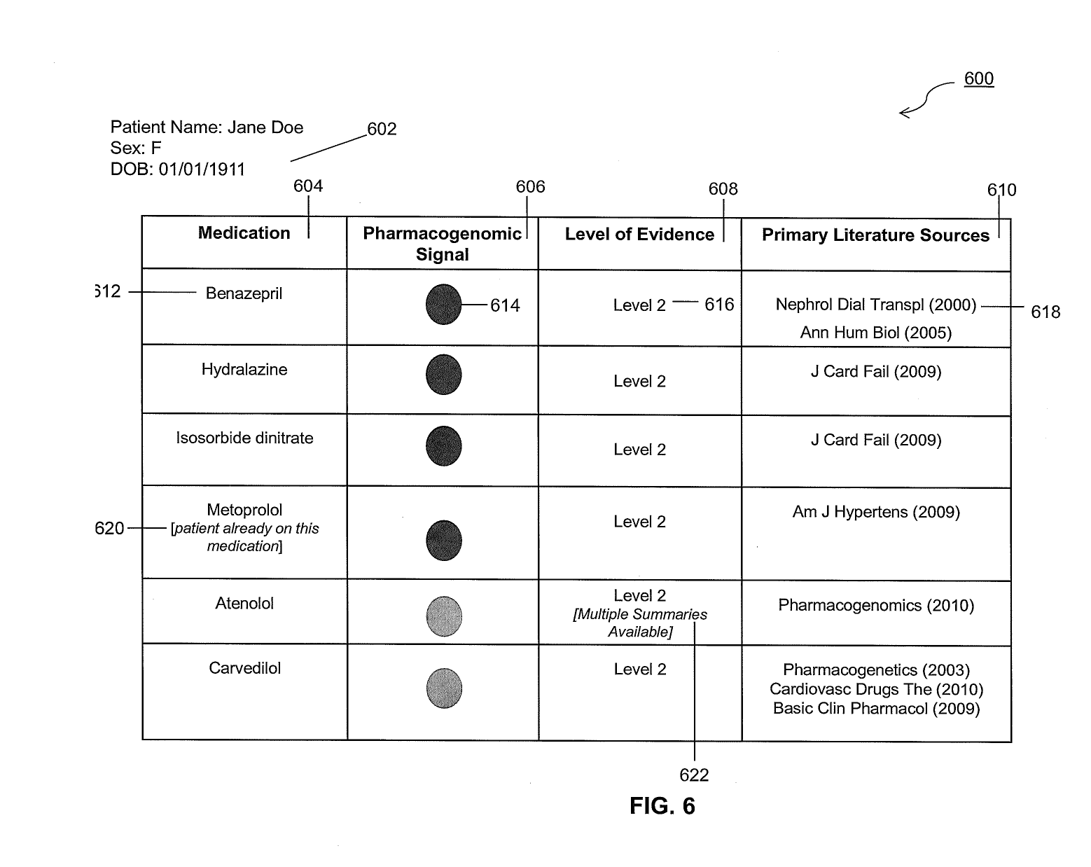

In certain embodiments, the interface also includes drug alternatives (see FIG. 5) and research study results (see FIG. 6). FIG. 5 is directed to a user interface communicating results of current medications taken by the patient. FIG. 6 is directed to a user interface communicating results of a medication for potential prescribing as queried by a physician.

As shown in FIG. 5, the user interface 500 includes patient identifying information 502 such as name, gender, and birthdate; however any identifying information is contemplated. The user interface 500 communicates information from the database directed to genomic and pharmacogenomic information pertaining to current medications taken by the patient 502. The user interface 500 includes a medication element 504, a pharmacogenomic signal element 506, a level of evidence element 508, and a pharmacogenomic alternative element 510.

It is understood that the medications illustrated in FIG. 5 are for exemplary purposes only and the invention is applicable to any drug. As shown, the medication element 504 may be directed to aspirin 512.

More specifically, the pharmacogenomic signal element 506 is an alert icon 514, shown in the form of a traffic light signal, but any form is contemplated. A “green” traffic light signal communicates a favorable relationship between the genotype and the drug, i.e., the patient has a genotype which suggests an improved chance of benefit or a decreased risk of toxicity with the drug. A “yellow” traffic light signal communicates a cautionary relationship between the genotype and the drug, i.e., the patient has a genotype associated with possible undesirable outcomes when using the medication. A “red” traffic light signal communicates a warning relationship between the genotype and the drug, i.e., the patient has a genotype that confers a significant increase in risk with use of the drug. The alert icon 514 may also communicate to the physician that there is no known pharmacogenomic information relevant to the drug or that pharmacogenomic information is associated with the drug but the patient has a genotype for which the composite pharmacogenomic relationship is neither favorable nor cautionary.

For each drug, a level of evidence element 508 is a numeric indicator ranging from a level 1 to a level 3 as shown by 516, however, any indicator is contemplated and the numeric indicator as shown is merely for exemplary purposes. In one embodiment, level 1 represents evidence from a well-performed large study including replication, or replicated by two or more large, well-performed studies; published dosing guidelines or Food & Drug Administration (FDA) label information likely exists. A level 2 represents evidence from at least one well-performed study of at least 100 subjects; or from several small or moderately—sized studies which show consistent results. A level 3 represents evidence from a relatively small single study (e.g., <100 subjects); or several similarly—executed contradictory studies exist.

Similar to the pharmacogenomic signal element 506, the pharmacogenomic alternative element 510 is resultant from a database of drug substitutions based on genomic and pharmacogenomic information. The pharmacogenomic alternative element 510 identifies the alternative drug 518 by name with an alert icon (shown in the form of a circle shape, but again, any form is contemplated). The alert icon communicates the relationship—favorable, cautionary, warning—between the genotype and the drug for the particular patient 502.

In order for a physician to discover potential pharmacogenomic interactions, the genomic prescribing system facilitates a search of a drug by name or disease. As shown in FIG. 6, the user interface 600 includes patient identifying information 602 such as name, gender, and birthdate; however any identifying information is contemplated. The user interface 600 communicates information from the database directed to genomic and pharmacogenomic information pertaining to any medication that may be taken by the patient 602. The user interface 600 includes a medication element 604, a pharmacogenomic signal element 606, a level of evidence element 608, and a primary literature sources element 610.

It is understood that the medications illustrated in FIG. 6 are for exemplary purposes only and the invention in applicable to any drug. As shown, the medication element 604 may be directed to benazepril 612. Again, the pharmacogenomic signal element 614 represents the known impact of each variant of the panel of gene variants on drug disposition, response, and/or toxicity and the level of evidence element 608 is directed to all evidence supporting the implicated pharmacogenomic relationship.

More specifically, the pharmacogenomic signal element 606 is an alert icon 614, shown in the form of a circle shape, but any form is contemplated. The color of the circle shape communicates a favorable relationship between the genotype and the drug, a cautionary relationship between the genotype and the drug, or a warning relationship between the genotype and the drug, as described more fully above. The alert icon 614 may also communicate to the physician that there is no known pharmacogenomic information relevant to the drug or that pharmacogenomic information is associated with the drug but the patient has a genotype for which the composite pharmacogenomic relationship is neither favorable nor cautionary.

For each drug, a level of evidence element 608 is an numeric indicator ranging from a level 1 to a level 3 as shown by 616, however, any indicator is contemplated and the numeric indicator as shown is merely for exemplary purposes. Again, the numerical value of the level of evidence element 608 represents the amount and content of evidence as described more fully above.

The primary literature sources element 610 is resultant from a database directed to connections between correlations and published literature. The primary literature sources element 610 identifies sources 618 related to a particular drug and gene and supports the relationship identified by the pharmacogenomic signal element 606. Sources may include research studies, peer reviewed articles, reports, non-peer reviewed published articles, secondary sources, published or unpublished raw data, published or unpublished processed data, anecdotal evidence, or other information related to maximizing the use of drugs in light of certain genes, groups of genes, or entire genomes in a patient.

It is contemplated the user interface(s) according to the invention may include text identification elements that may communicate status or additional information. For example, the text identification element may be a status element 620 that communicates the patient 602 is currently on a particular medication identified by the medication element 604.

As another example, the text identification element may be a clinical summary element 622 that communicates one or more clinical summaries are available for each drug-variant pair. Although the clinical summary element is shown as a text identification element that may be selected, such as by hovering over the element or selecting the link via a hyperlink, the clinical summary element may also be accessible by selecting any specific medication element 604 (612), pharmacogenomic signal element 606 (614), or level of evidence element 608 (616) related to a particular drug. It is also contemplated that clinical summary element may be accessible by selecting any specific primary literature source 610 (618).

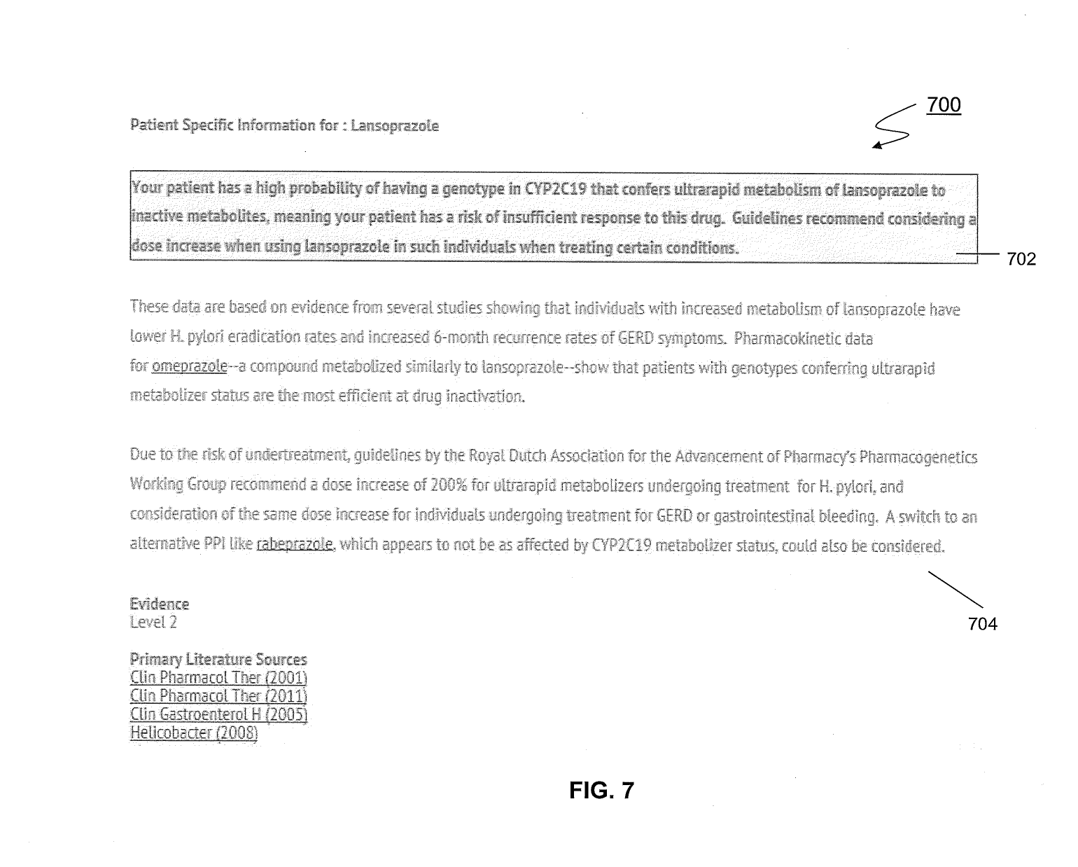

FIG. 7 illustrates an embodiment of a clinical summary element 700 according to the invention. As shown, the clinical summary element 700 is directed to lansoprazole, but any drug is contemplated. The clinical summary element 700 includes one or more recommendations as shown by 702 related to prescribing the medication for a particular patient. The summary 700 also includes support for the recommendations as shown by 704, which is based on interpretations generated from peer-reviewed studies by clinical experts; however it is contemplated the interpretations may be performed electronically such as by a custom designed algorithm.

For purposes of this application, it is contemplated that any information present within a user interface may be associated or linked to additional information upon selection. For example, selecting a level of evidence element, a clinical summary element, or a literature source, such as via a hyperlink, may enable display of additional information, for example, in a pop-up window.

The genomic prescribing system according to the invention may further include a user interface for the physician or subject to enter feedback regarding any aspect of the system or methods, including, for example, any interactions experienced by a subject from a particular medication. The feedback may be used to evaluate the system and methods, as well as to update any database with relevant findings. Additionally, the genomic prescribing system may further include a user interface for the physician or subject to participate in a survey, for example, the date and type of visit (routine, clinical, emergency) as well as any medication changes. The feedback and survey results may be used to evaluate the system and methods, as well as to update any database with relevant findings.

While the disclosure is susceptible to various modifications and alternative forms, specific exemplary embodiments of the invention have been shown by way of example in the drawings and have been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

1. A method for managing and communicating pharmacogenomic information, the method implemented on a computer system including at least a processor and a user interface, the processor of executing the method comprising the steps of:
receiving by the processor patient data including genotyping analysis data of one or more patients, wherein the genotyping analysis data includes genetic information of a patient related to one or more genetic markers;
obtaining by the processor pharmacogenomic data from one or more sources including research studies, peer reviewed articles, or reports related to the one or more genes and a medication;
creating by the processor a database describing one or more correlations between the one or more genetic markers and one or more responses to the medication by the one or more patients possessing the one or more genetic markers;
displaying on the user interface a plurality of elements, the plurality of elements including a medication element identifying the medication, a pharmacogenomic signal element identifying a relationship between the one or more genes and the medication, a level of evidence element identifying evidence from one or more studies performed on the medication and the one or more genetic markers.

2. The method for managing and communicating pharmacogenomic information according to claim 1, wherein the plurality of elements further includes a pharmacogenomic alternative element identifying a relationship between the one or more genes and the one or more alternative medications.

3. The method for managing and communicating pharmacogenomic information according to claim 1, wherein the plurality of elements further includes a primary literature sources element identifying published literature related to the medication and the one or more genes.

4. The method for managing and communicating pharmacogenomic information according to claim 1, wherein the relationship is a favorable relationship between the one or more genes and the medication suggesting an improved chance of benefit or a decreased risk of toxicity with the medication.

5. The method for managing and communicating pharmacogenomic information according to claim 1, wherein the relationship is a cautionary relationship between the one or more genes and the medication suggesting an undesirable outcome with use of the medication.

6. The method for managing and communicating pharmacogenomic information according to claim 1, wherein the relationship is a warning relationship between the one or more genes and the medication suggesting an increase in risk with use of the medication.

7. The method for managing and communicating pharmacogenomic information according to claim 1, wherein the pharmacogenomics signal element is in the form of a traffic light signal.

8. The method for managing and communicating pharmacogenomic information according to claim 1, wherein the genetic information of a patient related to one or more genetic markers is obtained using a mass spectrometry method across a panel of gene variants.

9. The method for managing and communicating pharmacogenomic information according to claim 8, wherein the panel of gene variants is one or more selected from the group consisting of a custom panel of gene variants and an existing panel of gene variants.

10. The method for managing and communicating pharmacogenomic information according to claim 1, wherein the plurality of elements further includes a clinical summary element including recommendations related to prescribing the medication based on the one or more genetic markers.

11. The method for managing and communicating pharmacogenomic information according to claim 1, wherein the genetic information of a patient related to one or more genetic markers is obtained using a fluorescent probe-based assay across a panel of gene variants.
